(19) United States
(12) Patent Application Publication
(10) Pub. No.: US 2015/0360153 A1
(43) Pub. Date: Dec. 17, 2015

(54) WASH-FLOW FILTER ASSEMBLY

(71) Applicant: HAMILTON SUNDSTRAND CORPORATION, Charlotte, NC (US)

(72) Inventors: Bruce Paradise, Avon, CT (US); Thomas James Killen, Wallingford, CT (US)

(21) Appl. No.: 14/306,546

(22) Filed: Jun. 17, 2014

(51) Int. Cl. B01D 35/00

(52) U.S. Cl. CPC B01D 35/005

(57) ABSTRACT

A wash-flow filter assembly is provided. The filter assembly includes a filtering device that includes a tube. At least one wash-flow passage is defined outside the filtering device and through which fluid passes as primary burn flow. A portion of the primary burn flow is configured to enter the tube from the passage as washed flow. A primary barrier acts as a filtering medium to catch contaminants within and, thereby, filter the contaminants out of the primary burn flow as it reaches the filtering device. A secondary barrier is positioned inside the filtering device, behind the primary barrier, and adjacent to the tube and configured to entrap contaminants that enter the filtering device through the primary barrier. The washed flow is configured to exit the tube as filtered fuel and be carried away out the filtering device. A fuel system is provided also that includes the wash-flow filter.

### BACKGROUND OF INVENTION

This invention relates, generally, to an aircraft-engine-control system and, more specifically, to a wash-flow filter assembly of such a system.

A fuel system, particularly for aircraft applications, requires relatively clean fuel. Toward that end, a wash-flow filter device is commonly used in such a system to provide maintenance-free filtering of contaminants from the fuel.

More specifically, the device is typically conical, cylindrical, or tubular in shape. A flow of, say, jet fuel enters the device at one end thereof as wash, motive, or burn flow. The device includes a perforated or woven screen material to act as a filter. As the fuel flows through the device, it is configured for the burn flow to make a ninety-degree turn to pass through the filter. Yet, momentum carries the burn flow such that only some of it passes radially in through the filter while a remainder of the burn flow (including particulates and fibers within the burn flow) travels downstream and exits an opposing end of the device in a straight line. The filter is designed to catch contaminants within the burn flow, which then temporarily remain within the filter. The fuel that has exited from the filter as washed flow is filtered fuel, which takes a turn and exits a side of the device short of the opposing end thereof As other burn flow continues to pass along the device, it is designed to remove the contaminants from the filter to provide self-cleaning of the device.

Carbon-fiber fuel tanks and components are used in a fuel system of an aircraft. Carbon-fiber contaminants, however, can pass through the filter and cause failure of components of the system downstream of the device. More specifically, loose tiny particles and long carbon fibers from manufacture of or damage or repair to the tanks and components can be liberated from the tanks and/or components during fueling of the aircraft and enter holes of the filter to pass through it. The particles and fibers can then be carried by washed flow to various hydraulic servo systems or devices (e.g. electrohydraulic servo valves) that are sensitive to contamination, which can cause malfunction of such systems and/or devices.

Accordingly, it is desirable to provide a wash-flow filter device that is resistant to carbon-fiber contaminants. More specifically, it is desirable to provide such a device that captures liberated and loose carbon-fiber contaminants from fuel flowing through the device and, thereby, minimizes or even prevents failure of components of an aircraft fuel system downstream of the device.

### BRIEF DESCRIPTION OF INVENTION

According to a non-limiting exemplary embodiment of the invention, a wash-flow filter assembly is provided. The filter assembly includes a filtering device that includes a tube. At least one wash-flow passage is defined outside the filtering device and through which fluid passes as primary burn flow. A portion of the primary burn flow is configured to enter the tube from the passage as washed flow. A primary barrier acts as a filtering medium to catch contaminants within and, thereby, filter the contaminants out of the primary burn flow as it reaches the filtering device. A secondary barrier is positioned inside the filtering device, behind the primary barrier, and adjacent to the tube and configured to entrap contaminants that enter the filtering device through the primary barrier. The washed flow is configured to exit the tube as filtered fuel and be carried away out the filtering device. A fuel system is provided also that includes the wash-flow filter.

The filter assembly uses metallic foam to capture liberated and loose carbon-fiber contaminants from fuel flowing through the filter assembly and is resistant to the carbon-fiber contaminants. Furthermore, the filter assembly minimizes or even prevents failure of components of the fuel system downstream of the filter assembly. In addition, the filter assembly is largely insensitive to high temperatures of fuel and an engine.

### BRIEF DESCRIPTION OF DRAWING

The subject matter that is regarded as the invention is particularly pointed out and distinctly claimed in the claims at the conclusion of the specification. The foregoing and other features and advantages of the invention are apparent from the following detailed description taken in conjunction with the accompanying drawing in which:

FIG. 1 is a schematic cross-sectional side view of a non-limiting exemplary embodiment of a fuel system with which a wash-flow filter assembly according to the invention is employed.

FIG. 2 is a schematic view showing fluid flow through the fuel system illustrated in FIG. 1.

### DETAILED DESCRIPTION OF INVENTION

Referring now to the figures, a non-limiting exemplary embodiment of a wash-flow filter assembly according to the invention is shown at 12. Although the filter assembly 12 is disclosed herein as being implemented for a fuel system of an aircraft, it should be appreciated that the filter assembly 12 can be implemented with any suitable fuel system. And, although the filter assembly 12 is disclosed herein as being implemented for an engine-control system of an aircraft, it should be appreciated also that the filter assembly 12 can be implemented with any suitable engine-control system or even system.

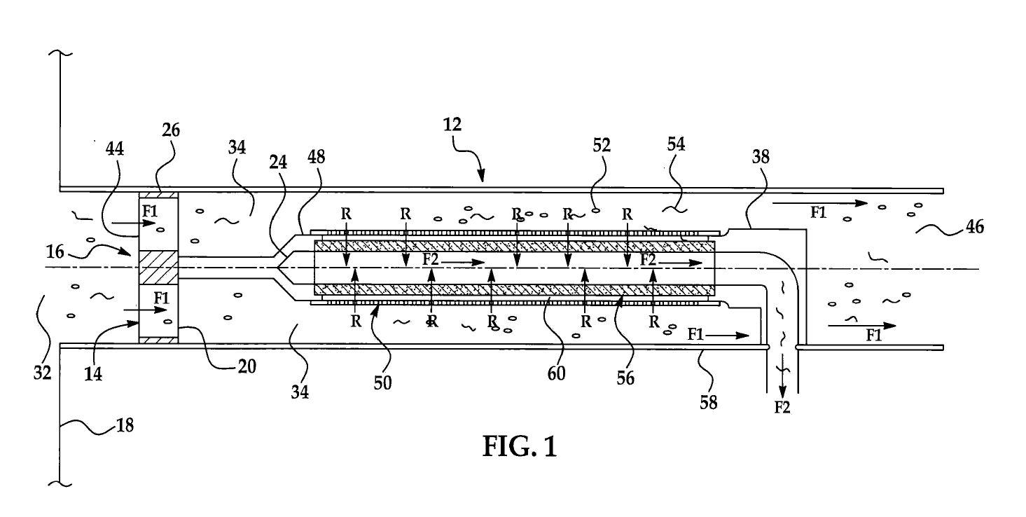

Referring now specifically to FIG. 1, a non-limiting exemplary embodiment of a fuel system 10 is illustrated when in a conventional wash mode. The fuel system 10 includes the filter assembly 12 that, in turn, has a filtering device 14. A bore 16 is located in a wall 18 of the fuel system 10 for receiving the filtering device 14. The filtering device 14 includes a header 20. A tube 24 runs from inside the header 20 and is formed of a material that blocks contaminants (e.g., a mesh or perforated screen material) to, therefore, act as a filter 24. A seal 26 is located in the header 20 to prevent fluid outside the bore 16 and inside the filtering device 14 from mixing with fluid inside the bore 16 and outside the filtering device 14. The fluid outside the bore 16 and inside the filtering device 14 is prevented from mixing with the fluid inside the bore 16 and outside the filtering device 14.

It should be appreciated that the fuel system 10 can have any suitable shape, size, and structure. It should be appreciated also that each of the filtering device 14, wall 18, header 20, tube 24, and seal 26 can have any suitable shape, size, and structure and the bore 16 can have any suitable shape and size. It should be appreciated also that the filtering device 14, bore 16, wall 18, header 20, tube 24, and seal 26 can have any suitable relationship with each other. It should be appreciated also that the fuel system 10 can have any suitable number and kind of components that, in turn, can have any suitable relationship with each other.

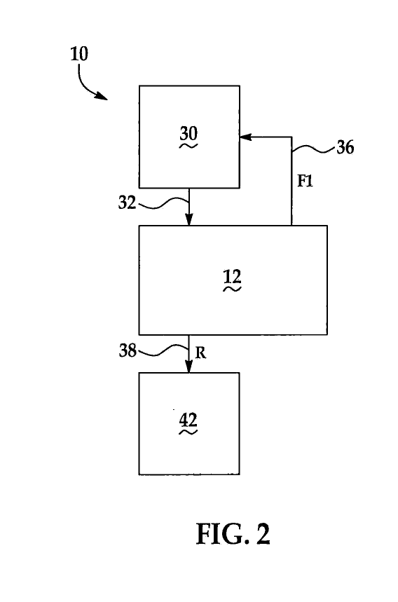

Referring now specifically to FIG. 2, fluid flow through the fuel system 10 is illustrated when in the conventional wash mode. Fluid (e.g., fuel) from a storage tank 30 enters the filter assembly 12 through an inlet 32 and then passes into at least one wash-flow passage 34 defined outside the filtering device 14 as motive or burn flow that includes particulate (particularly, carbon fiber). A portion of the burn flow is configured to enter the tube 24 from the passage(s) 34 through a pair of barriers (described below) as washed flow that does not include carbon-fiber contamination. The burn flow inside the passage(s) 34 and outside the tube 24 is carried away to an outlet return 36. The burn flow returns to the storage tank 30 to be later passed through the filtering device 14 again. The washed flow passes straight through the tube 24 and an outlet 38 of the filter assembly 12 to use for combustion within an engine 42. In particular, the engine 42 may be an aircraft engine 42.

More specifically, burn flow enters the filtering device 14 at a first end 44 and exits the filtering device 14 at a second end 46. A path of flow of the fuel through the passage(s) 34 is indicated by arrow “F1.” As the burn flow passes through the passage(s) 34, it is configured such that some of the burn flow turns and enters radially through a sidewall 48 of the tube 24. Arrows “R” indicate the flow through the sidewall 48. So, while momentum carries the burn flow such that some particulates within the burn flow continue to travel downstream and exit the filtering device 14 in a straight line, some of the burn flow passes radially into the tube 24. A path of flow of the washed flow through the tube is indicated by arrow “F2.”

It should be appreciated that fuel can flow through the fuel system 10 in any suitable manner. More specifically, it should be appreciated that fuel can enter the filter assembly 12 and filtering device 14, pass into and through the passage(s) 34, enter the tube 24 and through the sidewall 48, be carried away to the outlet return 36, return to the storage tank 30, and pass through the tube 24 and outlet 38 in any suitable manner. It should be appreciated also that the storage tank 30, engine 42, first end 44, second end 46, and sidewall 48 can have any suitable shape, size, and structure and the inlet 32, wash-flow passage(s) 34, outlet return 36, and outlet 38 can have any suitable shape and size. It should be appreciated also that the storage tank 30, inlet 32, wash-flow passage(s) 34, outlet return 36, outlet 38, engine 42, first end 44, second end 46, and sidewall 48 can have any suitable relationship with each other.

Referring now specifically to FIG. 1, the filter assembly 12 is illustrated in a conventional wash mode. The sidewall 48 includes a primary barrier 50 (e.g., a perforated or woven screen material 50) to act as a filtering medium. The primary barrier 50 is designed to catch contaminants within and, thereby, filter particles out of the burn flow (which then remain within the primary barrier 50) as the burn flow reaches the sidewall 48. Tiny particles 52 (e.g., silt) and relatively long carbon fibers or strands 54, however, may pass through the primary barrier 50 via holes of the primary barrier 50.

To obtain a filtered fuel, a secondary barrier 56 is positioned a short distance inside the filtering device 14, just behind the primary barrier 50, and adjacent to the tube 24. In an aspect, the secondary barrier 56 is attached to the tube 24. By way of example only, the secondary barrier 56 can be press-fitted, electron-beam welded, or tacked to the tube 24. The primary and secondary barriers 50, 56 are substantially co-extensive with respect to each other and extend substantially an entire length of the tube 24. In an aspect, the secondary barrier 56 is made of a foam-metal or metallic-foam material, such as Retimet®, and defines pores of the secondary barrier 56 respective diameters of which are on an order of 0.011 inch. The metallic-foam material is largely insensitive to high temperatures of the fuel and engine 42. The secondary barrier 56 is configured to entrap, retain, or stop the particles 52 and carbon strands 54 that entered the filtering device 14 through the primary barrier 50. In this way, the particles 52 and carbon strands 54 are not carried by the washed flow to various contamination-sensitive hydraulic servo systems or devices (like electrohydraulic servo valves). As a result, such systems or devices are protected from their malfunctioning.

The tube 24 takes a ninety-degree turn and exits a side 58 of the filtering device 14 short of the second end 46. The washed flow (without carbon-fiber contamination) is configured to exit the tube 24 as filtered fuel and be carried away out the filtering device 14 into the bore 16 and to the engine 42. As the burn flow moves along the path “F1,” the particles blocked by the sidewall 48 are washed out the second end 46 of the tube 24. Thus, the filtering device 14 is self-cleaning.

It should be appreciated that each of the primary and secondary barriers 50, 56 can have any suitable shape, size and structure. It should be appreciated also that the primary and secondary barriers 50, 56 can have any suitable relationship with each other and a remainder of the filtering device 14. It should be appreciated also that the secondary barrier 56 can be attached to the tube 24 in any suitable manner and be made of any suitable material. It should be appreciated also that the pores of the secondary barrier 56 can be of any suitable size. It should be appreciated also that the washed flow can exit the tube 24 and be carried away by the passage(s) 34 out the filtering device 14 into the bore 16 and to the engine 42 in any suitable manner. It should be appreciated also that the filtering device 14 can clean itself in any suitable manner.

The area and overall size of the secondary barrier 56 is designed to accommodate a full life of the filter assembly 12 and fuel system 10 into which the filter assembly 12 is installed. The filter assembly 12 can be replaced without replacing the fuel system 10. Of course, a new filter assembly 12 with overhaul and replacement of the fuel system 10 ensures that full life of the secondary barrier 56 is guaranteed.

The particles 52 and/or carbon strands 54 that are entrapped, retained, or stopped by the secondary barrier 56 can accumulate or build-up within a secondary burn flow in a space 60 defined between the primary and secondary barriers 50, 56. As such, in a further aspect (not shown), at least one vent or vent tab—particularly, a series of vent tabs—can be provided at a downstream side and/or end of the primary barrier 50 and configured to prevent such accumulation or build-up. The fuel flows out the space 60 and into the passage(s) 34.

As described above, in operation of the filter assembly 12 as a conventional barrier filter and in an exemplary non-limiting embodiment of the fuel system 10, burn flow can be forced to pass through the tube 24 radially, indicated by arrows “R.” In even a further aspect, the path “F1” can be closed off at the second end 46 to prevent burn flow from exiting the filtering device 14 into the outlet return 36 and passing back to the storage tank 30, thus making the primary and secondary barriers 50, 56 pure “barriers.” During this period of time, each of the primary and secondary barriers 50, 56 collects contaminant that is larger than respective sizes of the openings of the primary and secondary barrier 50, 56 and proceeds to become clogged until axial motive flow through the filtering device 14 allows wash (that is, when the path “F1” at the second end 46 is opened). Within a short period of time, the primary and secondary barriers 50, 56 are washed fully clean again.

The filter assembly 12 uses metallic foam to capture the liberated and loose carbon-fiber contaminants 52, 54 from the fuel flowing through the filter assembly 12 and is resistant to the carbon-fiber contaminants 52, 54. Furthermore, the filter assembly 12 minimizes or even prevents failure of components of the fuel system 10 downstream of the filter assembly 12. In addition, the filter assembly 12 is largely insensitive to high temperatures of the fuel and engine 42.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various non-limiting embodiments of the invention have been described, it is to be understood that aspects of the invention may include only some of the described embodiments. Accordingly, the invention is not to be seen as limited by the foregoing description, but is only limited by the scope of the appended claims.

1. A wash-flow filter assembly comprising:
a filtering device that includes a tube;
at least one wash-flow passage defined outside the filtering device and through which fluid passes as primary burn flow, a portion of the primary burn flow being configured to enter the tube from the passage as washed flow;
a primary barrier that acts as a filtering medium to catch contaminants within and, thereby, filter the contaminants out of the primary burn flow as the primary burn flow reaches the filtering device; and
a secondary barrier that is positioned inside the filtering device, behind the primary barrier, and adjacent to the tube and configured to entrap contaminants that enter the filtering device through the primary barrier, the washed flow being configured to exit the tube as filtered fuel and be carried away out the filtering device.

2. The wash-flow filter assembly of claim 1, wherein the secondary barrier is attached to the tube.

3. The wash-flow filter assembly of claim 2, wherein the secondary barrier is any of press-fitted, electron-beam welded, and tacked to the tube.

4. The wash-flow filter assembly of claim 1, wherein the primary and secondary barriers are substantially co-extensive with respect to each other and extend substantially an entire length of the tube.

5. The wash-flow filter assembly of claim 1, wherein the secondary barrier is made of a metallic-foam material.

6. The wash-flow filter assembly of claim 5, wherein the metallic-foam material is Retimet®.

7. The wash-flow filter assembly of claim 1, wherein the secondary barrier defines pores of the secondary barrier respective diameters of which are on an order of 0.011 inch.

8. The wash-flow filter assembly of claim 1, wherein the tube takes a substantially ninety-degree turn and exits a side of the filtering device and the filtered fuel is configured to exit and be carried away out the filtering device to an engine.

9. A fuel system comprising:
a wash-flow filter assembly including:
a filtering device that includes a tube;
at least one wash-flow passage defined outside the filtering device and through which fluid passes as primary burn flow, a portion of the primary burn flow being configured to enter the tube from the passage as washed flow;
a primary barrier that acts as a filtering medium to catch contaminants within and, thereby, filter the contaminants out of the primary burn flow as the primary burn flow reaches the filtering device; and
a secondary barrier that is positioned inside the filtering device, behind the primary barrier, and adjacent to the tube and configured to entrap contaminants that enter the filtering device through the primary barrier, the washed flow being configured to exit the tube as filtered fuel and be carried away out the filtering device.

10. The fuel system of claim 9, wherein the secondary barrier is attached to the tube.

11. The fuel system of claim 10, wherein the secondary barrier is any of press-fitted, electron-beam welded, and tacked to the tube.

12. The fuel system of claim 9, wherein the primary and secondary barriers are substantially co-extensive with respect to each other and extend substantially an entire length of the tube.

13. The fuel system of claim 9, wherein the secondary barrier is made of a metallic-foam material.

14. The fuel system of claim 13, wherein the metallic-foam material is Retimet®.

15. The fuel system of claim 9, wherein the secondary barrier defines pores of the secondary barrier respective diameters of which are on an order of 0.011 inch.
